(19) United States
(12) Patent Application Publication
(10) Pub. No.: US 2025/0024398 A1
(43) Pub. Date: Jan. 16, 2025

(54) API DRIVEN SUBSCRIBER IMS REGISTRATION STATUS CHANGES AND IMS ROUTING STEERING

(71) Applicant: AT&T Intellectual Property I, L.P., Atlanta, GA (US)

(72) Inventor: Timothy Yao, Cle Elum, WA (US)

(73) Assignee: AT&T Intellectual Property I, L.P., Atlanta, GA (US)

(21) Appl. No.: 18/894,129

(22) Filed: Sep. 24, 2024

Related U.S. Application Data
(63) Continuation of application No. 17/504,989, filed on Oct. 19, 2021, now Pat. No. 12,127,149.

(51) Int. Cl. H04W 60/00; G06F 9/54; H04W 8/04

(52) U.S. Cl. CPC H04W 60/00; G06F 9/547; H04W 8/04

(57) ABSTRACT

A method for discerning single registration subscribers and dual registration subscribers, and routes single registration traffic as internal and routes dual registration traffic as external.

### CROSS-REFERENCE TO RELATED APPLICATION(S)

The instant application is a continuation of U.S. patent application Ser. No. 17/504,989, filed Oct. 19, 2021. All sections of the aforementioned application(s) are incorporated herein by reference in their entirety.

### BACKGROUND

Rich Communication Services (RCS) is a communication protocol between mobile telephone carriers and between phone and carrier. RCS may replace short message service messages with a text-message system that provides phonebook polling for service discovery and may transmit in-call multimedia. It is part of broader internet protocol (IP) multimedia subsystem.

This background information is provided to reveal information believed by the applicant to be of possible relevance. No admission is necessarily intended, nor should be construed, that any of the preceding information constitutes prior art.

### SUMMARY

A system for discerning single registration subscribers and dual registration subscribers and routing single registration traffic as internal and routes dual registration traffic as external. This enables connectivity to exchange UCE and RCS messaging traffic between mobile network operators and other service providers with RCS messaging hubs.

In an example, an apparatus may include a processor and a memory coupled with the processor that effectuates operations. The operations may include receiving message, wherein the message is application programming (API) call; based on the message, detecting an indication to modify a service order code associated with rich communication services (RCS) messaging; or sending the indication of modification of the service order code to a core device, wherein the service order code indicates single registration for RCS messaging or dual registration for RCS messaging.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system for application programming interface (API) driven subscriber internet protocol (IP) multimedia subsystem (IMS) registration status changes or IMS routing steering.

FIG. 2 illustrates an exemplary method for API driven subscriber IP IMS registration status changes or IMS routing steering.

FIG. 3 illustrates a schematic of an exemplary network device.

FIG. 4 illustrates an exemplary communication system that provides wireless telecommunication services over wireless communication networks.

### DETAILED DESCRIPTION

As more and more global mobile network operators (MNO) (also referred herein as wireless service providers) are partnering up with external RCS messaging hubs to act as their messaging core, in which Tier 1 MNOs may have to work with the external RCS messaging hub to maintain IMS registration status for its own subscribers.

Conventionally, the parent network is unaware of the second IMS registration for RCS services at an RCS messaging hub. With this unawareness, the parent network will route RCS traffic as in-network traffic, resulting in session setup failure and missing messages.

When a subscriber that belongs to an MNO who has decided to use a RCS service provided by the external RCS messaging hub versus the service being provided by the MNO itself, the parent network should be informed by the external RCS messaging hub to indicate that a particular subscriber has registered with the external RCS messaging hub for RCS services. In this instance, RCS services are being provided by the external RCS messaging hub. These subscribers are known as dual registrants, as they have IMS-registered within its home MNO network for voice services, while the subscribers also have IMS-registered within the external RCS messaging hub for RCS services. Single registrants are those that have the voice and RCS messaging with the same service provider.

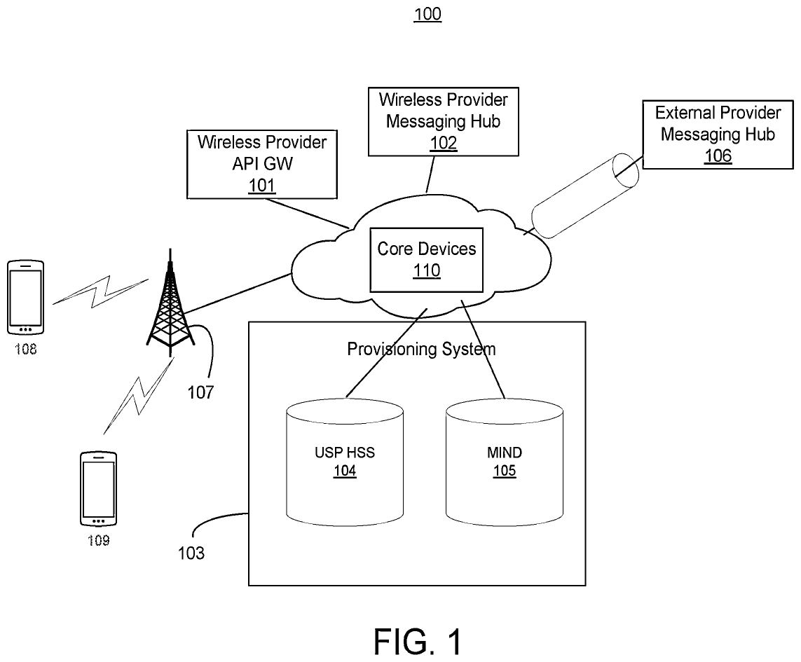

FIG. 1 illustrates an exemplary system for API driven subscriber IP IMS registration status changes or IMS routing steering, among other things. System 100 may include multiple include mobile device 108, mobile device 109, base station 107, wireless provider (WP) API gateway (GW) 101, WP messaging hub 102, core device 110, external provider (EP) messaging hub 106, or provisioning system 103, such as an IP multimedia system (IMS) core home subscriber server (HSS) 104 or MIND 105. The devices of system 100 may be communicatively connected with each other. WP API GW 101, WP messaging hub 102, core devices 110, HSS 104, and MIND 105 may belong to a first service provider (e.g., a wireless service provider). External provider messaging hub 106 may be associated with a second service provider that provides messaging services and is not necessarily a wireless service provider. Core device 110 may include one or more virtual or physical devices (other than the ones shown), such as Call Session Control Function (CSCF), Converged IP Messaging (CPM), E.164 Number
Mapping (ENUM), breakout gateway control function (BGCF), virtual Data Border Element (vDBE), or Interoperability Session Boarder Controller (I-SBC), which may help route the RCS messages as disclosed herein. Mobile device 108 and mobile device 109 may attempt to communicate with each other through RCS messaging, in which mobile device 108 and mobile device 109 may be communicating through different wireless service providers.

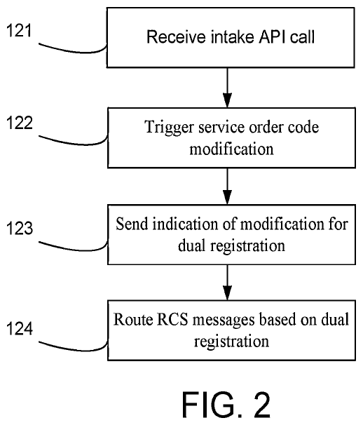

FIG. 2 illustrates an exemplary method for API driven subscriber IP IMS registration status changes or IMS routing steering.

At step 121, receiving, by WP API GW 101, a message an intake API call. The API call may be from WP messaging hub 102 and may be based on receiving, (from mobile device 108) by WP messaging hub 102, a request to execute RCS messaging. In an example, mobile device 108 may attempt to RCS message mobile device 109, which may be on the same wireless provider network or on different wireless provider networks.

At step 122, the API call of step 121 may trigger the modification of a service order code. In an example, the service order code may be called DualReg. DualReg may be used to indicate whether mobile device 108, for example, is registered to use single registration (e.g., SingleReg) or dual registration (e.g., DualReg) as described herein.

At step 123, sending an indication of a modified service code of step 122 to provisioning system 103. As disclosed herein, provisioning system 103 may include UPS HSS 104, MIND 105, or the like. In an example, UPS HSS 104 may modify an application server index (AsServerNameID) assigned to the “UCE terminating individual subscriber” Initial Filtering Criteria (IFC). The UCE is User Capability Exchange and may be used to understand what the mobile terminated (MT) capabilities are. When adding, AsServerNameID is a BGCF Fully Qualified Domain Name (FQDN), while when removing, AsServerNameID is a Presence application server (AS). “Adding” is when subscriber is switching from Single Registration to Dual Registration. “Removing” is when subscriber is switching from Dual Registration to Single Registration.

With continued reference to step 123, MIND 105 may add or remove DualReg as a value in the “acwipmsgtcos” or the like attribute. The “acwipmsgtcos” is a MIND databased attribute, a Terminating Class of Service attribute. When adding, DualReg as a value is added in the “acwipmsgtcos” attribute. When removing DualReg as a value is removed in the “acwipmsgtcos” attribute.

At step 124, routing RCS messages from mobile device 108 based on the modified service code. The routing is done by one or more of the core devices 110. In an example for dual registration traffic, for outbound UCE Session Initiation Protocol (SIP) traffic, when S-CSCF determines BGCF FQDN as AsServerNameid, S-CSCF routes it as Interop traffic, onto BGCF. Interop traffic is traffic that an MNO needs to route to a partner carrier (foreign traffic, and not native intra traffic). In an example for single registration traffic, when S-CSCF sees Presence AS FQDN as AsServerNameid, S-CSCF routes it as internal traffic, toward Presence AS of the wireless service provider.

With continued reference to step 124, in another example for dual registration traffic, for outbound RCS Messaging SIP traffic, when RCS AS sees DualReg in “acwipmsgtcos” attribute, RCS AS routes traffic as Interop (e.g., external) traffic, onto BGCF. In another example for single registration, when RCS AS does not see DualReg in “acwipmsgtcos” attribute, RCS AS routes traffic in internal traffic, onto terminating S-CSCF.

The disclosed subject matter results in single registration traffic being routed as internal traffic, while dual registration traffic being routed as Interop traffic, toward the external messaging hub.

It is contemplated that service providers may provide different ways for WP messaging hub 102 to be informed of DualReg or SingleReg, such as external messaging hub 106 or another device informing WP messaging hub 102. The method steps herein may be executed on one device or a plurality of devices.

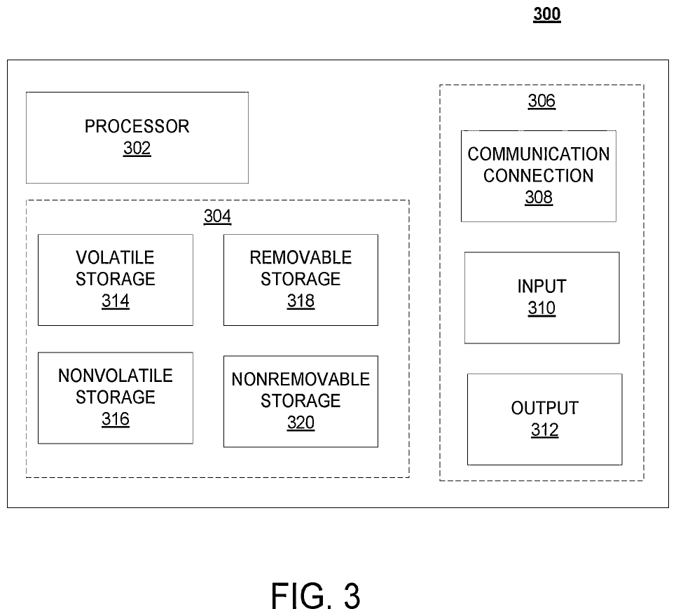

FIG. 3 is a block diagram of network device 300 that may be connected to or comprise a component of cellular network 112 or wireless network 114. Network device 300 may comprise hardware or a combination of hardware and software. The functionality to facilitate telecommunications via a telecommunications network may reside in one or combination of network devices 300. Network device 300 depicted in FIG. 3 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 3 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled
to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 3) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

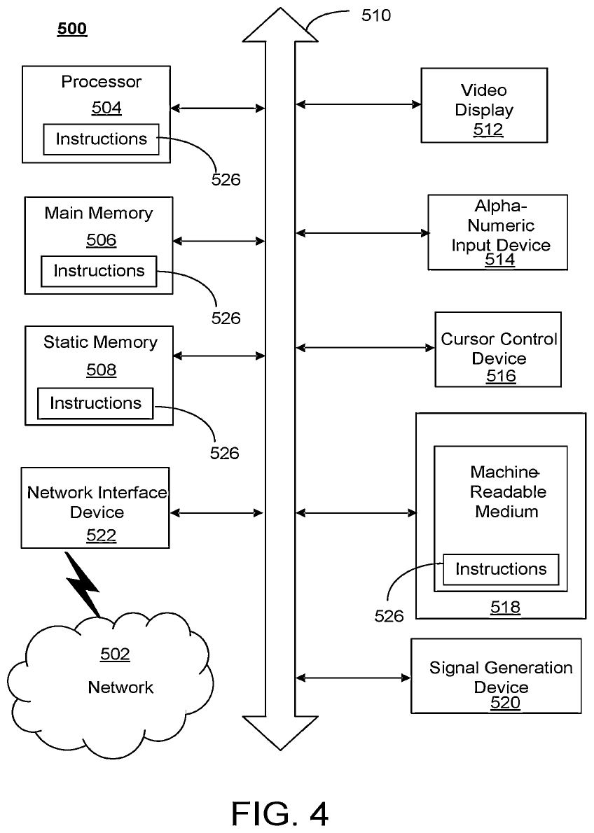

FIG. 4 depicts an exemplary diagrammatic representation of a machine in the form of a computer system 500 within which a set of instructions, when executed, may cause the machine to perform any one or more of the methods described above. One or more instances of the machine can operate, for example, as processor 302, mobile device 108, mobile device 109, base station 107, core device 110, and other devices of FIG. 1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life-especially for simple M2M devices-through enhanced wireless management.

While examples of a system in which API driven subscriber IP IMS registration status changes or IMS routing steering alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—API driven subscriber IP IMS registration status changes or IMS routing steering—as illustrated in the Figures, specific terminology is employed for the sake of clarity.

The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for API driven subscriber IP IMS registration status changes or IMS routing steering. The disclosed subject matter allows for discerning single registration subscribers and dual registration subscribers, and routes single registration traffic as internal and routes dual registration traffic as external. The system allows single registration voice, UCE, and RCS Messaging traffic to route as is, while dual registration voice as in-network traffic and dual registration UCE/RCS messaging traffic as out-of-network traffic. A method, system, computer readable storage medium, or apparatus provides for receiving message, wherein the message is application programming interface (API) call; based on the message, detecting an indication to modify a service order code associated with rich communication services (RCS) messaging; or sending the indication of modification of the service order code to a core device, wherein the service order code indicates single registration for RCS messaging or dual registration for RCS messaging. The core device may be a virtual network function. The subsequent RCS messaging may be routed to an external messaging hub from an internal messaging hub based on the service order code indicating dual registration or single registration. It is contemplated that similar indicators to dual or single may be used and provide the intended functions as disclosed herein.

All combinations in this paragraph (including the removal or addition of steps) are contemplated in a manner that is consistent with the other portions of the detailed description.

What is claimed:

1. A method comprising:
receiving, by a gateway and from a first messaging hub, an application programming interface (API) call, wherein the API call is based on the first messaging hub receiving a request to execute rich communication services (RCS) messaging from a first mobile device;
triggering, based on the receiving of the API call, a modification of a service order code, resulting in a modified service order code, wherein the modified service order code indicates whether the first mobile device is registered to use a single registration or a dual registration; and
routing, by one or more core devices, a plurality of RCS messages from the first mobile device to a second mobile device based on the modified service order code.

2. The method of claim 1, wherein the first mobile device is on a first wireless provider network and the second mobile device is on the first wireless provider network, and wherein the modified service order code indicates use of the single registration.

3. The method of claim 1, wherein the first mobile device is on a first wireless provider network and the second mobile device is on a second wireless provider network that is different from the first wireless provider network, and wherein the modified service order code indicates use of the dual registration.

4. The method of claim 3, wherein the routing of the plurality of RCS messages comprises routing the plurality of RCS messages to a second messaging hub associated with the second wireless provider network.

5. The method of claim 1, further comprising sending routing instructions based on the service order code.

6. The method of claim 1, wherein based on the triggering the one or more core devices modify the service order code, resulting in the modified service order code.

7. The method of claim 6, wherein the one or more core devices comprise a virtual network function.

8. The method of claim 6, wherein the one or more core devices comprise a home subscriber server.

9. An apparatus comprising:
a processor; and
memory coupled with the processor, the memory storing executable instructions that when executed by the processor cause the processor to effectuate operations, the operations comprising:
receiving, from a first messaging hub, an application programming interface (API) call, wherein the API call is based on the first messaging hub receiving a request to execute rich communication services (RCS) messaging from a first device;
triggering, based on the receiving of the API call, a modification of a service order code, resulting in a modified service order code, wherein the modified service order code indicates whether the first device is registered to use a single registration or a dual registration; and
routing a plurality of RCS messages from the first device to a second device based on the modified service order code.

10. The apparatus of claim 9, wherein the first device is on a first wireless provider network and the second device is on the first wireless provider network, and wherein the modified service order code indicates use of the single registration.

11. The apparatus of claim 9, wherein the first device is on a first wireless provider network and the second device is on a second wireless provider network that is different from the first wireless provider network, and wherein the modified service order code indicates use of the dual registration.

12. The apparatus of claim 11, wherein the routing of the plurality of RCS messages comprises routing the plurality of RCS messages to a second messaging hub associated with the second wireless provider network.

13. The apparatus of claim 9, wherein the operations further comprise sending routing instructions based on the service order code.

14. The apparatus of claim 9, wherein based on the triggering a core device modifies the service order code, resulting in the modified service order code.

15. The apparatus of claim 14, wherein the core device comprises a virtual network function.

16. The apparatus of claim 14, wherein the core device comprises a home subscriber server.

17. A computer readable storage medium storing computer executable instructions that when executed by a computing device cause said computing device to effectuate operations, the operations comprising:
receiving an application programming interface (API) call, wherein the API call is based on a first messaging hub receiving a request to execute rich communication services (RCS) messaging from a first device;
triggering, based on the receiving of the API call, a modification of a service order code, resulting in a modified service order code, wherein the modified service order code indicates whether the first device is registered to use a single registration or a dual registration; and
routing at least one RCS message from the first device to a second device based on the modified service order code.

18. The computer readable storage medium of claim 17, wherein the at least one RCS message comprises a plurality of RCS messages.

19. The computer readable storage medium of claim 17, wherein the routing is facilitated via a core device, and wherein when the triggering indicates that the first device is being registered to use the dual registration the core device modifies an application server index to a fully qualified domain name.

20. The computer readable storage medium of claim 19, wherein when the triggering indicates that the first device is being registered to use the single registration the core device modifies the application server index to a presence application server.
